(19) United States
(12) Patent Application Publication
(10) Pub. No.: US 2007/0043792 A1
(43) Pub. Date: Feb. 22, 2007

(54) Image processing system

(76) Inventor: Philip Paul O'Brien, Nottingham (GB)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 10/565,045

(22) PCT Filed: Jul. 13, 2004
(86) PCT No.: PCT/GB04/03036

§ 371 Date: Jan. 17, 2006

(30) Foreign Application Priority Data
Jul. 16, 2003 (GB) 0316654.3

(51) Int. Cl. G06F 17/30

(52) U.S. Cl. 707/205

(57) ABSTRACT

This invention relates to an image processing system for capturing images from an event and for distributing images so obtained to one or more clients. The system may comprise a terminal associated with a camera and a first editing facility, wherein the terminal is configured to receive a master image file corresponding to an image of the event captured by the camera to store the master image file, to create a preview image file of a smaller file size, and to transmit the preview image file to the first editing facility, and wherein the first editing facility is configured to transmit a preview image file to a client.

This invention relates to an image processing system for capturing images from an event and for distributing images so obtained. In particular, although not exclusively, this invention relates to capturing photographs of action at a sporting event, such as a football match, and to editing the photographs where desired and to distributing the photographs to one or more clients such as mobile phone users.

Modern media demands the availability of images taken at events of public interest to be made available to the public on a worldwide scale in ever decreasing time scales. For example, there is a demand for images from major sporting events to be distributed in as close to real time as possible. Images may be distributed to any number of clients for any number of eventual output formats. For example, the images may be for inclusion in newspapers, websites or for sending as multimedia files to mobile phones (e.g. MMS messaging via XML and image files). In addition merely to forwarding images, it may be desirable to edit the images or to add other information such as one or more captions prior to distribution.

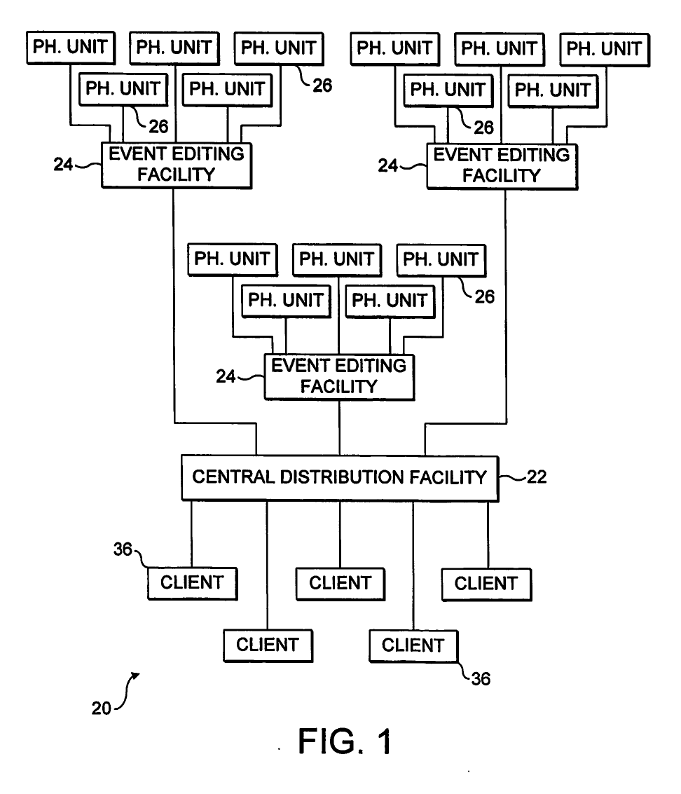

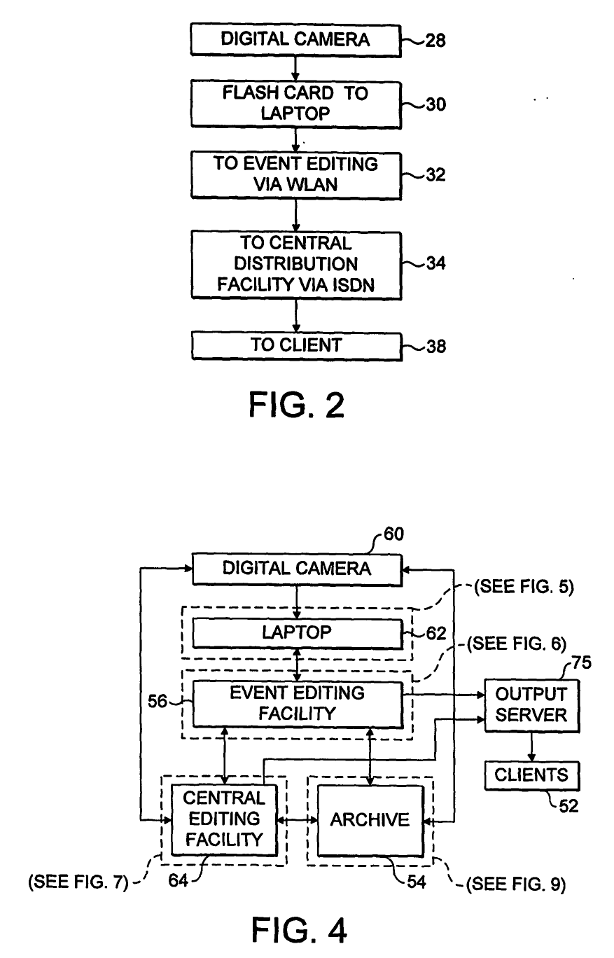

A known image processing system 20 for taking photographs at an event and for subsequent editing and distribution of images so collected is shown in FIG. 1. FIG. 2 shows, in simplified form, a method of operating the system of FIG. 1. The system 20 comprises a plurality of event editing facilities 24. Each of the event editing facilities will be located at an event, for example in a media centre provided at a sports stadium.

In turn, each of the event editing facilities 24 is linked to a number of photographic units 26. The photographic units 26 correspond to a photographer taking photographs with a digital camera, at 28 of FIG. 2, that saves each image so acquired on a flash card. The photographer then transfers these images to a nearby laptop by moving the flash card from camera to laptop at 30. The laptop takes these images and transmits them to the event editing facility 24 at 32 via a wireless local area network (WLAN).

The event editing facility 24 comprises a number of editors provided with computers for receiving and displaying the images sent by the photographic units 26. The editors can select any of the available images and perform editing as desired. This editing may include cropping photographs and/or adding captions. Once editing is complete, the image files are then transmitted via ISDN lines to a central distribution facility 22 at 34. The central distribution facility 22 is located remote from the event and receives images from a plurality of event editing facilities 24 that may be geographically widespread. The central distribution facility 22 is used to relay images to one or more clients 36 at 38 for them to use as they wish. In this way, photographs taken at an event may be distributed to clients 36 ready for their use within a time scale of around five to eight minutes.

Against this background, the present invention resides in an image processing system for collecting images of an event and for distributing an image so taken to one or more clients, the system comprising a terminal associated with a camera, and a first editing facility; wherein the terminal is configured to receive a master image file corresponding to an image of the event captured by the camera, to store the master image file, to create a preview image file from the master image file where the preview image file has a smaller file size than the master image file, and to transmit the preview image file to the first editing facility; and the first editing facility is configured to transmit a preview image file to a client.

In this way, the ultimate delivery time of an image captured at an event to a client can be reduced because the time taken to send image files within the image processing system is less. This is achieved by transmitting smaller image files relating to a preview image rather than transmitting bulkier master image files in each instance. This is highly advantageous where, for example, a wireless network is used to link the device to the first editing station where file transfer across the network may be intermittent and small file sizes increase the likelihood of successful transmission.

Smaller image file size can be achieved in any number of ways: for example, the resolution of the image may be reduced, a detail may be extracted from the master image, the image may be converted to grayscale or compression techniques may be used either singularly or in any combination.

Optionally, the first editing facility comprises an editing tool operable to facilitate editing an image associated with a preview image file and to amend the associated file in response thereto. This may allow detailed editing of the image or may have limited functionality, e.g. only to allow rotation of the image to correct orientation errors such as the image being upside down or presented on one of its sides.

Preferably, the terminal is configured to look in the master image file for data corresponding to a preview image in the master image file and, if such data is found, to extract the data to the preview image file. This is a quick and convenient way of creating preview files as the data may already be prepared courtesy of the software operating on the camera. However, this will not always be the case so where data corresponding to a preview image is not found, the master image is preferably resized and the data corresponding to the resized image is written to the preview image file. The terminal may be configured to allow the size to be used when resizing the master image to be adjusted through a graphical user interface or the like.

Conveniently, the terminal is further configured to transmit the master image file to the first editing facility upon receiving a request from the first editing facility and the first editing facility is configured to facilitate editing an image associated with a master image file and to amend the associated file in response thereto and to transmit a master image file to a client. This allows flexibility in that master images that will be stored at a higher resolution than the preview images or are a larger image can be retrieved where the preview image proves to be of interest. In this case, the bulkier master image file may be sent to the first editing facility. Put another way, the bulkier master image files will not be sent across the network if the preview image is not of interest.

Optionally, the photographic processing system further comprises a second editing facility configured to facilitate editing an image associated with a preview image file and to amend the associated file in response thereto and to transmit a preview image file to a client and wherein the first editing facility is operable to transmit preview image files to the second editing facility. The second editing facility is preferably a shared facility located some distance away from the first editing facility. For example, the second editing facility may be a common facility that received image files from a plurality of first editing facilities. Each of these first editing facilities may be located at an event of interest.

Preferably, the first editing facility is further configured to transmit the master image file to the second editing facility upon receiving a request from the second editing facility and/or wherein the terminal is further configured to transmit the master image file to the second editing facility upon receiving a request from the second editing facility, and wherein the second editing facility is configured to facilitate editing an image associated with a master image file and to amend the associated file in response thereto and to transmit a master image file to a client. This makes the high resolution master images available for editing and/or onward transmission at the second editing facility.

Advantageously, the second editing facility has an associated archive and wherein the first and/or second editing facilities are configured to send preview image files to the archive. Optionally, the first and/or second editing facilities are configured to send master image files to the archive.

Preferably, the photographic processing system further comprises an output server through which image files are sent for onward transmission to a client. Advantageously, the output server is configured to regulate the delivery of image files to one or more clients.

Optionally, either the first or second editing facility is configured to create MMS messages or a slide show that include preview images. The slide show may, for example, be an http slide show.

Conveniently, the editing facility is configured to receive a file containing text describing an event, to search the text for pre-defined terms, to create a new file containing text and images upon finding a pre-defined term and to transmit the new file to a client. Preferably, the editing facility is configured automatically to extract text from the incoming text file and to write the text to the new file or automatically to retrieve an image from an archive and to write the image to the new file.

The present invention also extends to an image processing system for collecting images of an event taken by a camera and for distributing an image so obtained to one or more clients, the system comprising a terminal and first and second editing facilities; wherein the terminal is operable to receive and store an image of the event as an electronic image file and to transmit the image file to the first editing facility; the first editing facility is local to the event and is configured

(a) to receive the image file transmitted by the terminal,

(b) to determine a suitable editing station for displaying the image associated with the image file, and to display the image at the editing station,

(c) to facilitate selection of the image displayed at the editing station,

(d) to facilitate selection of an output destination for the selected image file wherein available output destinations include the second editing facility and one or more clients, and

(e) to transmit the selected file to the selected output destination; and the second editing facility is remote from the event and is configured

(a) to receive an image file transmitted by the first editing facility,

(b) to display the image associated with the image file at an editing station,

(c) to facilitate selection of the displayed image,

(d) to facilitate editing of the selected image,

(e) to facilitate selection of an output destination for the selected image file, wherein available output destinations include one or more clients, and

(f) to transmit the selected file to the selected output destination.

The above system provides flexibility such that photographs may be distributed quickly without removing the ability for editing to be performed. In particular, where photographs are for distribution quickly, they may be sent direct from the first editing facility without delaying them by routing them through a second editing facility which may be a central facility or the like. For example, photographs may be selected at the first editing facility and transmitted to form an http slide show in around twenty seconds.

The invention also resides in a method of processing images taken at an event and for distributing an image so captured to one or more clients, the method comprising the steps of: receiving an electronic image of the event as a master image file; storing the master image file in a memory located at the camera location; creating a preview image file from the master image file, the preview image file being of a smaller file size than the master image file; transmitting the preview image file to a first editing facility; and transmitting the preview image file to a client.

The invention also resides in an image processing facility operable to receive a preview image file containing images of an event, to facilitate selection of an output destination for the preview image file wherein available output destinations include a further image processing facility and one or more clients, and to transmit the preview image file to the selected output destination.

As will be appreciated by the skilled person, the principle applied to the image processing system defined above can be applied to other data relating to an event. For example, whilst the above generally relates to still images taken of action at an event, moving images and even text can be handled in an equivalent way. Further details of moving images and text files are given later. Accordingly, the invention also resides in a data file processing system for collecting data files containing data relating to an event and for distributing such data to one or more clients, the system comprising a terminal and a first editing facility; wherein the terminal is configured to receive a master data file corresponding to data relating to the event, to store the master data file, to create a preview data file from the master image file where the preview data file has a smaller file size than the master data file, and is configured to transmit the preview data file to the first editing facility; and the first editing facility is configured to transmit the preview data file to a client.

The invention also resides in a computer when programmed: to receive image files containing an image of an event; to assign image files to one of a plurality of viewing lanes; to display the plurality of viewing lanes, each viewing lane being displayed in a window and including an image or images associated with one or more image files assigned to that viewing lane; to facilitate selection of an image from at least one of the plurality of viewing lanes and to display an enlarged view of the selected image; to facilitate selection of a client; and to send the image file associated with the selected image to the selected client.

Other preferred features of the above systems, method and computer are set out in the appended claims. The invention also resides in a computer program comprising program instructions for causing a computer to operate as described above and in a computer readable medium having such a computer program recorded thereon.

In order that the invention can be more readily understood, reference will now be made, by way of example only, to the accompanying drawings, in which:—

FIG. 1 shows a photographic processing system according to the prior art;

FIG. 2 is a simplified representation of a method of processing photographs from an event using the prior art system of FIG. 1;

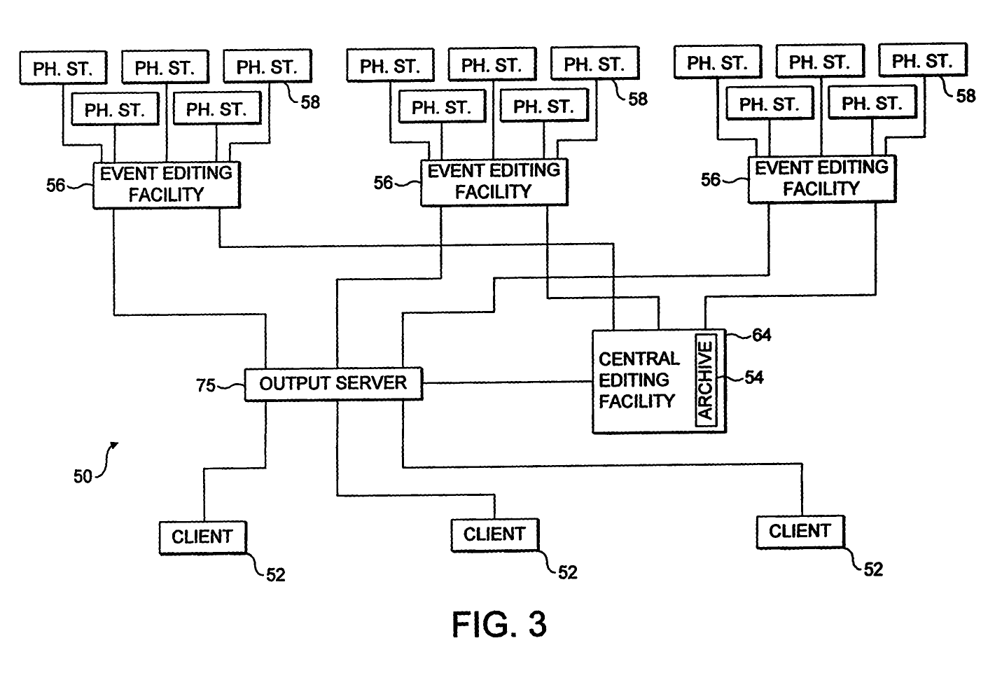

FIG. 3 shows a photographic processing system according to an embodiment of the present invention;

FIG. 4 is a simplified representation of a method of processing photographs from an event according to an embodiment of the present invention;

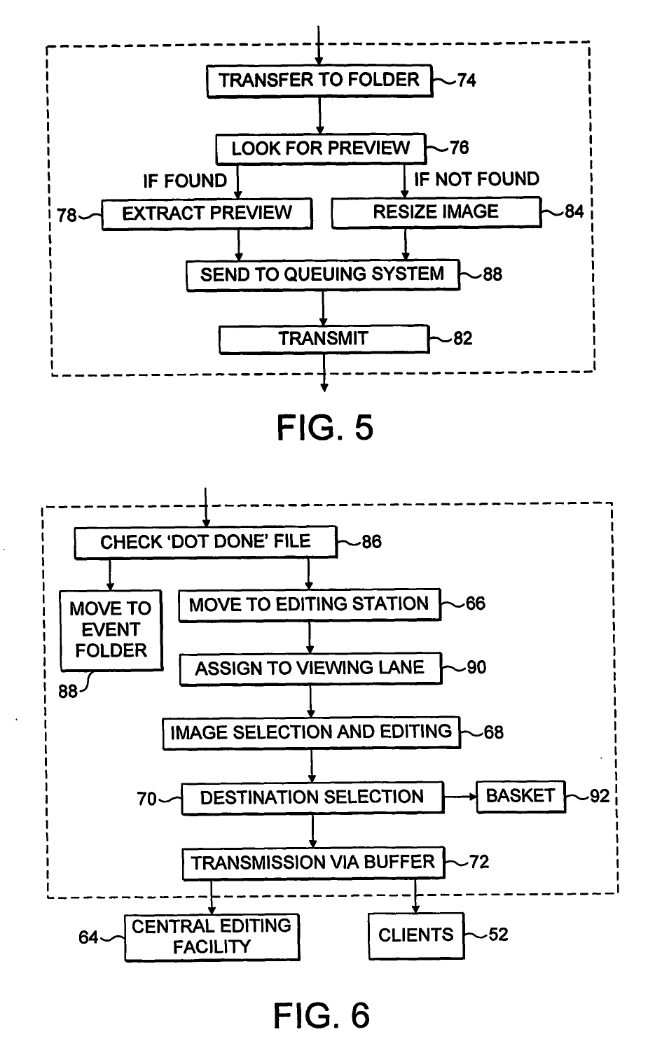

FIG. 5 shows the steps performed by the laptop of FIG. 4;

FIG. 6 shows the steps performed by an event editing facility of FIG. 4;

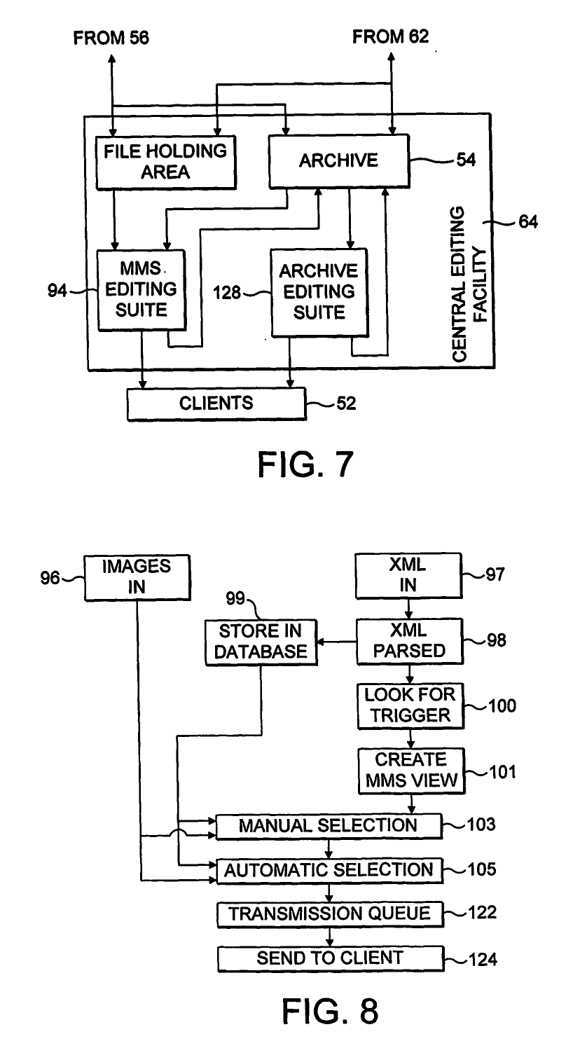

FIG. 7 shows the central editing facility of FIG. 4 in greater detail;

FIG. 8 shows the steps performed by the MMS editing suite of FIG. 7;

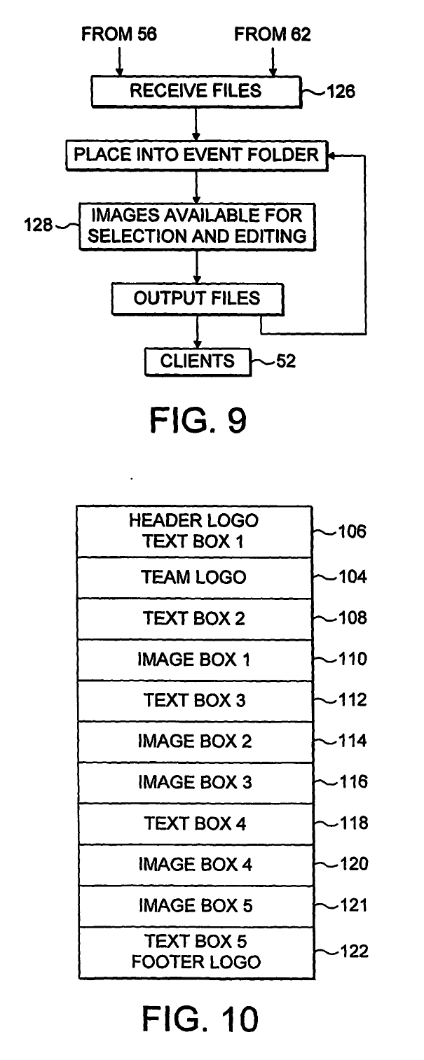

FIG. 9 shows operation of the archive of FIG. 4; and

FIG. 10 shows a display format of an MMS message created by the system of FIG. 3.

FIGS. 1 and 2 relate to prior art and have been discussed in the introduction. Accordingly, no further discussion is needed here.

Turning now to an exemplary embodiment of the present invention, FIG. 3 shows a system 50 for taking photographs at an event, for allowing selection and editing of one or more of the photographs so taken, and for distributing any of the photographs (whether edited or not) to one or more clients 52 and also to an archive 54.

The system 50 comprises a plurality of event editing facilities 56, each of which is located at an event. The event may be one of any number of possibilities, for example a sporting event such as a football match, a political event such as a debate at a seat of government or an entertainment event such as a music concert. For the purposes of this exemplary embodiment, the event is illustrated as a football match held at a stadium although it will be appreciated that the present invention is not limited to this example but enjoys far wider applicability.

Each event editing facility 56 is connected to a number of photographic stations 58 located at the event via a wireless fidelity (WiFi) network. Each photographic station 58 comprises a digital camera 60 that is hard-wired to a laptop computer 62 that, in turn, is operable to transmit and receive data across the WiFi network. Any particular photographic station 58 may be manned by a photographer or may be automatic.

The photographic stations 58 are located around the perimeter of the football pitch and within gantries looking down on the pitch, whilst the event editing facility 56 is located in the press box of the stadium. The event editing facility 56 and the photographic stations 58 may be transportable so that they can be removed from the stadium after the event is over and taken to another event location to cover a different event or they may be located permanently at the stadium.

As indicated generally in FIG. 3, the photographic stations 58 all use the WiFi network to feed images to the event editing facility 56. Images may be edited using the event editing facility 56 and may be transmitted (whether edited or not) either direct to one or more clients 52 via an output server 75 or to a central editing facility 64 located remote from the stadium via ISDN lines. The central editing facility 64 may be used for editing of the images it receives and for transmitting images to clients 52 via output server 75. The central editing facility 64 also hosts the archive 54.

FIG. 4 shows a simplified representation of a method of operating the system 50 of FIG. 1 according to an embodiment of the present invention. A summary of the method will now be presented followed by a more detailed discussion thereafter.

Starting at 60, a photographer takes photographs of action at the football match as circumstances suggest (for example, the photographer may take a photograph of a footballer scoring a goal and the ensuing celebrations). These images are stored digitally directly on the hard drive of the associated laptop 62. Once an image is stored, it is ready for the laptop 62 to transmit it to the event editing facility 56 via the WiFi network.

The image arrives at the event editing facility 56 to be received by a computer (e.g. a server connected to a plurality of editing stations). The image is made available for selection at one or more editing stations at 66 of FIG. 6. An operator at an editing station will have a number of images presented in this way, any of which may be selected at 68. If selected, an output destination may be chosen for that image at 70, the image may optionally be edited and the image may be transmitted subsequently at 72 to the chosen output destination. The output destination may result in a direct transmission to a client 52 via the output server 75 (that merely logs the image file being forwarded and ensures smooth delivery using a transmission queueing system) or transmission to the central editing facility 64 via ISDN lines (either to be made available immediately for selection at the central editing facility 64 or for storage in an archive 54).

Detailed editing of any of the images is possible at the central editing facility 64. The images may either be selected direct from an incoming feed from a current event editing facility 56 or from the archive 54. Once selected, an image may be edited in any number of ways and/or it can be sent either to a client 52 via the output server 75 or to the archive 54 (either for the first time or for re-storing after editing).

So, in further detail, a digital camera 60 of the type commonly available (e.g. a Canon EOS-1D or a Nikon D1X) takes photographs of the football match. The photographs taken in this way are saved direct to the hard drive of the laptop 62 as image files with an appropriate filename. As these are the original image files created and stored by the camera, they will be referred to hereinafter as master image files. The laptop 62 may be connected to the camera 60 in any convenient way. Hard-wiring using firewire cables are preferred as they can transmit data at a high rate between camera 60 and laptop 62, although USB connection is an acceptable alternative. The images are saved to a folder at 74 preferably as jfif files (using jpeg compression techniques), although the use of other file formats such as tiff or raw would be acceptable.

Automatic image file transfer need not be visible to the photographer. In fact, the laptop 62 may be kept closed, i.e. so that its display and keyboard are not accessible while the event is taking place.

Once a master image file has been saved at 74, the software attempts to find a preview of the master image within the saved jfif file, as is shown in FIG. 5 at 76. The preview size is defined to be any image with its longest side in the range of 175 to 520 pixels. If a preview image is found, the data associated with the preview image is extracted from the master image file at 78 and sent as a preview image file in jfif format to an output folder within a queueing system at 80 ready for onward transmission at 82 to a server at the event editing facility 56.

If a preview is not found within the master image file, the software performs a resizing of the master image according to a predefined resolution at 84 and the resulting data describing the resized image is sent to the same queueing system as has been described for the preview images at 80. Both preview images and resized images will be referred to generically as preview images from hereon, and the same convention will be adopted for their associated files.

The master image that comes directly from the camera 60 is renamed and stored on the laptop 62 in such a way that it can be sent to a folder in the archive 54 held at the central editing facility 64 by the software provided on the laptop. This means that the master image is available for later retrieval by the central editing facility 64, if required. Transmission to the archive 54 can be performed after the event is finished, thereby avoiding transmission of bulky master image files whilst the event is ongoing that would otherwise slow distribution of selected images to clients 52.

The master image files are renamed according to a unique naming scheme which allows unambiguous identification of what event the image relates to and exactly when the master image was taken and on which laptop 62 it is stored. The file name comprises a concatenation of a four character event i.d. (e.g. frst), the date the master photograph was taken as ddmmyy (e.g. 301202), the time the master photograph was taken as hhmmssxxx (where x is milliseconds to give, e.g., 182434478), a two character laptop i.d. (e.g. c8) and a four character image i.d. (e.g. abdx).

In order for the time stamp part of the master image file name to be universally true, all cameras 60 and laptops 62 present at an event must be synchronised. This is performed using NTP (Network Time Protocol). The time stamp should be as close as possible to the operation time of the camera shutter.

Software associated with the queuing system 88 checks the output folder for any image files (i.e. master or preview image files) that may be waiting to be transmitted either to the event editing facility 56 or to a client 52. If one or more image files are found, they are sorted into a time and date order before an ftp connection is attempted to the appropriate output destination. When a connection is established, the queueing system uploads the image files followed by “dot done” file to indicate that the file transfer is complete. A connection is open only while image file transfer is in progress and, during upload, the image file is written with a temporary file name before being renamed when image transmission is complete.

Where the output is the event editing facility 56, receipt of the “dot done” file also informs the server that it can begin processing the image file. Where a connection fails, or where the upload is not successful for any reason, the queuing system 88 will keep trying to send an image file until it is successfully delivered.

As will be appreciated, the functionality of the laptop 62 means that it may be useful to provide a user interface to allow several options to be adjusted by a photographer or administrative user. This may also allow the photographer or administrative user to monitor image file transmission, as follows. This feature is not necessary though as these options can all be predefined. Details of the ftp procedure can be adjusted to suit a particular situation: the ftp user name, the ftp host name, the ftp password and the ftp directory to which the image files should be uploaded can all be defined.

In addition, the size to be used by the laptop 62 when resizing a master image at 84 in the event that a preview is not found can be set. If a value is not entered, the master size image will be sent: where a mixture of preview image files and master size image files are waiting in the queueing system 88, the preview image files are always sent first. The send order for image files leaving the queuing system 88 can also be toggled between normal date order and reverse date order. Finally, a debug option may be switched on such that debugging text is logged to a file and/or displayed on screen during image file transmission. This allows the photographer to monitor the file transfer process.

As mentioned above, files are transferred between laptops 62 and the event editing facility 56 via a WiFi network that provides each photographic station 58 with at least 1 Mbit capacity. For example, an 802.11b network with multi-access points on a distributed backbone may be used. High gain antennas of typically 5-12 dB per photographic station 58 are employed.

Turning now to the event editing facility 56, FIG. 6 shows the steps it performs.

Initially, the server associated with the event editing facility 56 monitors the incoming feeds from the photographic stations for any new image files. Upon detecting a new image file and its “dot done” file at 86, the server examines an event configuration file to determine which editing stations should be presented with the associated preview image. The server then moves the incoming preview image files into a directory at the events level at 88, thus indicating that the preview images have been received and processed, and then makes a copy of the preview image file and sends it to an incoming folder of the appropriate editing station at 66.

Each editing station will be provided with a display, linked to the server either directly or via a personal computer provided at the editing station. The display can show any number of images derived from images files held in the incoming folder at 66.

The preview images displayed are arranged into a maximum of six viewing lanes at 90 and each of these viewing lanes can receive images from multiple feeds (i.e sent by multiple photographic stations 58). That said, a feed from any particular photographic station 58 normally exists only in one lane. Each viewing lane has an associated viewing window shown on the display that contains the preview images within that lane. Each image shown within the viewing window will also display the exact time and date the image was taken. An operator can then select a suitable image from the viewing window at 68 for editing or for onward transmission either to a client 52 or to the central editing facility 64.

Each viewing lane has its own associated processor that can be controlled from a small control panel presented on the right-hand side of the display. Each processor will have three states and four inputs. The three states are “stopped”, “running” and “idle”. “Stopped” corresponds to when the processor is not currently running and is not available to process any new images. This state is indicated using red highlighting of the associated viewing window. “Running” corresponds to when the processor is currently processing an image and is indicated using yellow highlighting and the associated viewing window also shows the photographic station 58 from where the image is derived. “Idle” indicates that the processor is currently running but is unaware of any images awaiting processing and is indicated using green highlighting. The associated viewing window would also indicate the feeds that the lane is monitoring.

Inputs to the lanes comprise “start”, “stop”, “clear” and “reload”. “Start” changes the state of a processor from stop to idle, whilst “stop” does the reverse. “Clear” causes all images in a viewing lane to be cleared. “Reload” takes every image that has been processed in a lane and reloads all those images into its viewing window.

When a lane processor is “running”, it monitors the arrival of new image files into its lane. When a new image file has been detected, the associated image file is moved into a holding area to prevent it being picked up again (for example, by another editing station). Once the image file has been moved into the holding area, the lane processor will present the associated preview image in the viewing window for the viewing lane, along with the next-newest images already held in that lane.

For each of the six viewing lanes, one of the images being displayed within that lane can be selected at 68 so that it appears in a larger window to allow editing such as rotating the image through 90 degrees in order to display the image in the correct landscape or portrait orientation. In addition, once a preview image is selected, the master image taken by the camera 60 can also be requested. Where a master image is selected, this is retrieved from the laptop 62 of the photographic station 58 that provided the preview image file. The master image may then be edited as per editing of a preview image described above. Accordingly, the bulky master image files need only be sent across the WiFi network when specifically requested from the event editing facility 56. This helps to ensure speedy data transmission across the WiFi network.

Selecting an image from the viewing window at 68 allows an output destination to be selected at 70 from a list of check boxes. For example, a client 52 may be selected from a list of suitable clients 52. Alternatively, the central editing facility 64 may be selected or the image maybe sent to a basket at 92 that allows a sequence of images to be collected. These images can form either an animated sequence or a static sequence of images. For example, the images may be sent later as a slide show for display on a website. Once an output destination has been selected for an image at 70, its associated image file is submitted to the output server 75.

The output server 75 is invoked whenever an image file has been submitted for transfer from any source. The output server is conveniently located at the same location as the central editing facility 64. The image file is sent from the output server 75 to the designated output at 72 using ftp either directly or via a buffer. The purpose of the buffer is to ensure that an image reaches a given age before it is forwarded. Additionally, a delay may be set between each transfer of an image file to ensure any particular image is not updated too quickly: this is useful where the images are being provided to accompany an audio commentary of an event and a delay is required to ensure synchronisation.

The method by which the image file is sent via ftp can also be adjusted when the output destination is selected at 70. For example, an image file may be sent with a “dot done” file to indicate when file transfer is complete. Additionally, the image may be sent under a temporary file name before being renamed when a “dot done” file has been received. A selection of XML file schemas or other data formats (such as IPTC and EXIF data files) can also be sent along with the image file to contain the time and photographic station 58 associated with the image along with a caption. This is particularly useful where the eventual output destination will be an MMS server. The image can also be renamed to a new standard according to the eventual ftp location that is specified to suit a client 52 who, for example, may not wish to have a long complex file name.

Turning now to the central editing facility 64, it receives image files from the event editing facility 56, as can be seen from FIGS. 4 and 7. In addition, master image files can be requested by the central editing facility 64 in which case they are retrieved from the laptop 62 of the appropriate photographic station 58 at the appropriate event. These image files may be delivered ready for immediate selection and editing or may be delivered to the archive 54. Editing can be performed at the central editing facility 64 in order to suit a client's preferred output format. Editing may be performed using standard image editing software and may include rotation of the image, cropping and for captions to be added either directly to appear on the image or to be written to a file associated with the image (this aspect will be described in further detail below).

An important application of the present invention is for providing MMS messages to mobile phone users via an MMS server. Accordingly, the central editing facility 64 has a dedicated MMS editing suite 94. The steps performed by the MMS editing suite 94 are shown in more detail in FIG. 8.

The MMS editing suite 94 receives as inputs image files (either preview image files or master image files) at 96 and XML files at 97. The XML files are provided by a third party and contain text that describes the football match (or other event). In the context of this embodiment, they contain general information about the football match such as the teams playing and also current information such as news of a goal that has just been scored. Accordingly, some parts of the XML files remain the same for successive messages and some parts vary.

Software provided for the MMS editing suite 94 will monitor a delivery folder for receipt of the XML files at 97. When a new XML file is received or if an existing XML file is updated, the software will read the latest version of the XML file and parse the file at 98 to extract relevant information it contains. This information is added to a database at 99 (e.g. details of the football match such as the venue, the teams playing, what the associated image is—perhaps details of a goal scored such as the time of the goal, the scorer, the score, etc.). As an updated XML file will contain information repeated from earlier files, the software can merely identify updated information and write this to the database. This can, for example, be accomplished by using a “replace into” SQL statement.

The XML file is then checked to see whether or not it contains any pre-defined text that will act as a trigger, as shown at 100. For example, a text string indicating that a goal has been scored or that half time/full time has been reached may act as a trigger. When a trigger is found, a process for creating a MMS message for distribution to interested clients is started.

Accordingly, the XML file is placed into a job pool at 98. The MMS editing suite 94 will contain a plurality of MMS stations: XML files may be picked from the job pool 98 from any of the MMS stations. Hence, each MMS station will have a display showing a series of boxes indicating what XML files are waiting to be processed. These boxes are colour coded depending upon which MMS station is assigned to be deal with the event associated with the XML file. The boxes will indicate event specific details, for example teams playing in a football match, a scoring player, etc. Clicking on one of the boxes will load that job into a MMS editor window to display an MMS view as indicated at 101. This process should lock that XML file to prevent any other MMS station subsequently attempting to edit it. Once an event is over, XML files from the event should no longer be visible in the job pool.

FIG. 10 shows a typical MMS view format. As can be seen, the MMS file will be viewed as a series of text boxes and image boxes. Images can be assigned to any image box using the MMS station by selecting images from the image lanes. Text can also be added to any text box using the MMS station. Some of the image boxes and/or text boxes may be filled automatically according to selected criteria. For example, the second box 104 may be filled with a team or sponsor logo that is merely obtained from a database table with reference to the selected XML file (i.e. software may examine the XML file to determine which teams are playing in the football match and create an MMS file for one of the teams bearing that team's logo: the MMS file may then be sent to fans subscribing to an MMS service provided by that football team).

The MMS file preferably presents the view shown in FIG. 10, along with the following information. Text box one at 106 should contain event specific information, i.e. the names of the teams playing in the football match, identified from the XML file sent from the event. The team logo box at 104 is as described above. Text box two at 108 should contain information on the relevant action being shown in the associated image file, for example a scorer of a goal being displayed in image box one at 110. Text box three at 112 should then contain the time of the goal. The content of the remaining boxes 114-120 can be chosen freely. For example, text box five at 122 could contain some predefined advertising text.

To facilitate manual selection at 103 of FIG. 8, the MMS editing station has a display showing three picture lanes, akin to the lanes of the event editing facility, along with a larger view to show a currently selected image.

The first picture lane will display images from an event spanning a time period of two minutes either side of the time stamp on the currently selected image. The second picture lane provides images found by running a search on an existing image library and will display all images within a picture library associated with the current event. For example, it may show all images relating to a goal scorer. The third picture lane is broadly similar to the second picture lane, and displays images found from a further search performed on an picture library returning any generic pictures in the library, for example pictures of fans cheering or a team mascot.

Automatic selection at 105 is performed by software picking up appropriate images and/or text from the image archive and/or XML database. For example, the team logo can be inserted into box 122 automatically by searching the incoming XML file for the teams playing in the football match, and then creating two MMS views, one to be sent to fans of one of the teams playing, the other to be sent to the other set of fans.

Once the MMS view is complete and a destination has been selected, it can be submitted using a button presented on the display thereby changing the screen into a processing format that displays a final “OK” button to be selected as final confirmation that the MMS view is ready for delivery to a client.

Upon selection of the “OK” button, the MMS view is converted into a corresponding XML file and image files that are sent to a transmission queue at 122 belonging to the output server 75. The images are resized and reformatted according to a client's preference, e.g. the images might be sharpened, lightened or the contrast increased. The XML file is given a unique file name and is logged in a table along with the data that was sent with the file and which images were included in the MMS view. The table will also contain information on the editor who designed the MMS view and the time the files were submitted to the queuing system of the output server 75 at 122. The resulting output files will also be available for re-editing of the MMS view should it be required.

The output server 75 will eventually send the XML and image files associated with each MMS view at 124 from the transmission queue 122, with the image files being sent first followed by the associated XML file.

As mentioned previously, an archive 54 is associated with the central editing facility 64. FIG. 9 shows further details of the archive 54. The archive 54 contains image files that are available for editing at any time, whether the event with which they are associated is current or not. Images can be pushed into the archive from the event editing facility 56 as indicated in FIG. 4. Alternatively, images can be pushed into the archive 54 after being selected in the central editing facility 64. In addition, the laptop 62 may send master image files to the archive 54 after the event is over. In any event, image files are received by the archive 54 at 126.

The archive 54 allows “old” images to be manipulated from the central editing facility 64 in much the same way as the “current” images can be manipulated from the event editing facility 56.

Accordingly, an archive editing suite 128 of the central editing facility 64 presents a six lane view, with events being assigned to different viewing lanes. Each lane's view allows an image to be selected at 128 and displayed in greater detail in a larger window. Each viewing lane should refresh on a timer and move the oldest fifty images in that lane into an “old” folder. Any particular lane can be switched between an “old” folder and a “current” view (i.e. showing the images most recently sent the archive 54 from the event editing facility). This feature may also be employed, if desired, in the event editing facility 56.

Preview images may be pushed into the archive 54 direct from the event editing facility 56 without the master image file being requested. These “current” preview image files may be picked up from the archive 54 before the master image files have been sent from the corresponding photographic station's laptop 62. Hence, a mechanism is included whereby if a master image is requested from a preview image selected from the archive 54, the software looks in the archive 54 for the corresponding master image file and, if not found, transfers the master image file from the corresponding photographic station's laptop 62.

The six lane view should display associated information with the images such as the event with which it is associated as well as the current status of any download or queues associated with that event. Each viewing lane within the archive editing suite 128 should have a drop-down box available for allowing the event associated with that lane to be changed by selecting an event from a pre-defined list. The drop-down box should also allow the lane to be switched to a non-standard event. An override option allows the six lanes to be reset to their initial associated events. It should also be possible for an administrative user to change the configuration of the multilane viewing screen. Such an administrative user would have just a read-only view facility.

The embodiment described above is capable of delivering images to a client 52 in a much reduced timescale compared to the prior art system. For example, it allows delivery of an MMS message to a mobile phone around three minutes after the last image contained in the message was captured at a photographic station 58. Better still, a slide show can be prepared and delivered for viewing on a website or WAP-enabled mobile phone within 20 seconds of the last image it contains being captured at a photographic station 58.

It will be evident to the skilled person that features described above with respect to the exemplary embodiment can be varied without departing from the scope of the present invention.

For example, specific details of viewing screens presented by the editing facilities may be freely varied. There are many well-known ways of presenting the images for selection and for allowing editing of the images and/or the creation of MMS views that may be adopted.

The methods of file transfer, whether it be by ftp or otherwise, can be freely chosen from those in common use. For example, the camera 60 and laptop 62 need not be hard-wired together all of the time. Instead, images taken by the camera 60 could be saved to a flash card or other suitable data storage medium inserted in the camera 60 which is then removed by the photographer and transferred to a card reader (or other device such as a floppy disk drive) provided by the laptop 62 for transfer of the image files to the laptop's hard drive. File transfer could be automatic or could be effected manually by the photographer.

Automatic transfer can be controlled by software operating on the laptop 62. This software could monitor the image files stored on the camera's flash card and, upon detecting a new file, grabs the image files from the flash card.

Where a transportable data storage medium is used, such as a flash card, the laptop 62 may display a graphical user interface that is colour coded to inform the photographer whether or not image file transmission is currently taking place. Accordingly, the screen or a window within the screen may be highlighted in red where image transmission is underway to warn the photographer not to remove the compact flash card or other medium. Once transmission is complete, the display or window will be highlighted in green thus indicating to the photographer that the compact flash card or other medium may be removed. If manual picture transfer is preferred, the software may present the photographer with a button or the like to be selected to begin downloading the images from the camera 60. After image file transfer, the original file on the flash card or other medium may or may not be deleted: this option can be set via the software provided on the laptop 62.

However image file transfer is affected, the images are preferably saved to a folder on the laptop 62 as jfif files (using jpeg compression techniques) as was described previously.

Examples of hardware and software given above are merely for the purposes of illustration and alternatives with broadly similar functionality may be used instead. For example, the photographic stations 58 need not have a laptop 62, but could have any type of commonly available computer that has the facility to store image files from the camera 60, to create preview image files and to transmit preview and master image files onwards. In particular, a handheld device such as a PDA (personal digital assistant) may be a good alternative to a laptop. In addition, a WiFi network is only used as a matter of convenience. Wired networks are an acceptable alternative. Similarly, the use of ISDN lines described above is but a preferred option: other types of lines allowing data transfer may be substituted such as GSM, GPRS and ADSL.

While the embodiments described above are all in the context of an image processing system, the invention may be applied to processing many types of files describing an event. For example, the above description generally describes still images, but the invention obviously lends itself to processing moving images as well. For example, mpeg-format files may be handled in addition to the jpeg-format files described above. The skilled person will appreciate that preview files may be formed from master moving-image files. The preview files may contain only a short sequence taken from the file or may contain one or more stills taken from the file.

Alternatively, text files may be processed in accordance with the broad concept of the invention. For example, lengthy text files describing an event (e.g. a full commentary of a football match) may be used as the basis for preview files. The preview files may contain key sentences extracted from the master file or may contain a concatenation of keywords: the preview files may, for example, be created using standard text abstracting software.

1. An image processing system for collecting images of an event and for distributing an image so taken to one or more clients, the system comprising a terminal associated with a camera, and a first editing facility; wherein
the terminal is configured to receive a master image file corresponding to an image of the event captured by the camera, to store the master image file, to create a preview image file from the master image file where the preview image file has a smaller file size than the master image file, and to transmit the preview image file to the first editing facility; and
the first editing facility is configured to transmit a preview image file to a client.

2. The image processing system of claim 1, wherein the first editing facility comprising an editing tool operable to facilitate editing an image associated with a preview image file and to amend the associated file in response thereto.

3. The image processing system of claim 1 or 2, wherein the terminal is configured to look in the master image file for data corresponding to a preview image in the master image file and, if such data is found, to extract the data to the preview image file.

4. The image processing system of claim 3 wherein, if data corresponding to a preview image is not found, the master image is resized and the data corresponding to the resized image is written to the preview image file.

5. The image processing system of any preceding claim, wherein the terminal is further configured to transmit the master image file to the first editing facility upon receiving a request from the first editing facility and the first editing facility is configured to facilitate editing a master image associated with a master image file and to amend the associated file in response thereto and to transmit a master image file to a client.

6. The image processing system of any preceding claim, further comprising a second editing facility configured to facilitate editing an image associated with a preview image file and to amend the associated file in response thereto and to transmit a preview image file to a client and wherein the first editing facility is operable to transmit preview image files to the second editing facility.

7. The image processing system of claim 6, wherein the first editing facility is further configured to transmit the master image file to the second editing facility upon receiving a request from the second editing facility and/or wherein the terminal is further configured to transmit the master image file to the second editing facility upon receiving a request from the second editing facility, and wherein the second editing station is configured to facilitate editing an image associated with a master image file and to amend the associated file in response thereto and to transmit a master image file to a client.

8. The image processing system of claim 6 or claim 7, wherein the second editing facility has an associated archive and wherein the first and/or second editing facilities are configured to send preview images to the archive.

9. The image processing system of any of claims 6 to 8, wherein the first and/or second editing facilities are configured to send master images to the archive.

10. The image processing system of any preceding claim, further comprising an output server through which image files are sent for onward transmission to a client.

11. The image processing system of claim 10, wherein the output server is configured to regulate the delivery of image files to one or more clients.

12. The image processing system of any preceding claim, wherein either the first or second editing facility is configured to create MMS messages that include preview images.

13. The photographic processing system of claim 12, wherein the editing facility is configured to receive a file containing text describing an event, to search the text for pre-defined terms, to create a new file containing text and images upon finding a pre-defined term and to transmit the new file to client.

14. The image processing system of claim 13, wherein the editing facility is configured automatically to extract text from the incoming text file and to write the text to the new file.

15. The image processing system of claim 13 or claim 14, wherein the editing facility is configured automatically to retrieve an image from an archive and to write the image to the new file.

16. The image processing system of any preceding claim, wherein either the first or second editing facility is configured to create http slide shows that include preview images.

17. An image processing system for collecting images of an event taken by a camera and for distributing an image so obtained to one or more clients, the system comprising:
a terminal and first and second editing facilities; wherein
the terminal is operable to receive and store an image of the event as an electronic image file and to transmit the image file to the first editing facility;
the first editing facility is local to the event and is configured
(a) to receive the image file transmitted by the terminal,
(b) to determine a suitable editing station for displaying the image associated with the image file, and to display the image at the editing station,
(c) to facilitate selection of the image displayed at the editing station,
(d) to facilitate selection of an output destination for the selected image file wherein available output destinations include the second editing facility and one or more clients, and
(e) to transmit the selected file to the selected output destination; and
the second editing facility is remote from the event and is configured
(a) to receive an image file transmitted by the first editing facility,
(b) to display the image associated with the image file at an editing station,
(c) to facilitate selection of the displayed image,
(d) to facilitate editing of the selected image,
(e) to facilitate selection of an output destination for the selected image file, wherein available output destinations include one or more clients, and
(f) to transmit the selected file to the selected output destination.

18. A method of processing images taken at an event and for distributing an image so captured to one or more clients, the method comprising the steps of:
receiving an electronic image of the event as a master image file;
storing the master image file in a memory located at the camera location;
creating a preview image file from the master image file, the preview image file being of a smaller file size than the master image file;
transmitting the preview image file to a first editing facility; and
transmitting the preview image file to a client.

19. The method of claim 18, comprising further steps of editing an image associated with the preview image file and amending the associated file in response thereto.

20. The method of claim 18 or claim 19, comprising the steps of checking the master image file for data corresponding to a preview image in the full image file and, if such data is found, extracting the data to the preview image file.

21. The method of claim 20 comprising the steps of, where data corresponding to a preview image is not found, resizing the master image and writing the data corresponding to the resized image to the preview image file.

22. The method of any of claims 18 to 21, comprising the further steps of sending a request for a master image file from the first editing facility, transmitting the master image file from the memory to the first editing facility in response thereto, editing the image associated with the master image file at the first editing facility, amending the associated file in response to the editing and transmitting a master image file to a client.

23. The method of any claims 18 to 22, further comprising the steps of transmitting preview image files from the first editing facility to the second editing facility, editing the image associated with the preview image file at the second editing station and amending the associated file in response thereto, and transmitting a preview image file to a client from the second editing facility.

24. The method of claim 23, further comprising the steps of transmitting the master image file to the second editing-facility from the first editing facility and/or the memory upon receiving a request from the second editing facility, editing the image associated with the master image file at the second editing facility and amending the associated file in response thereto, and transmitting a master image file to a client.

25. The method of claim 23 or claim 24, comprising the step of sending preview image files to an archive associated with the second editing facility.

26. The method of any of claims 23 to 25, master image files to an archive associated with the second editing facility.

27. The method of any of claims 18 to 26, further comprising sending image filed to an output server for onward transmission to a client.

28. The method of claim 27, wherein the output server regulates the delivery of image files to one or more clients.

29. The method of any of claims 18 to 28, further comprising the step of creating an MMS message that includes preview images.

30. The method of claim 29, further comprising the steps of receiving a file containing text describing an event, searching the text for pre-defined terms, creating a new file containing text and images upon finding a pre-defined term and transmitting the new file to client.

31. The method of claim 30, comprising the step of automatically extracting text from the incoming text file to the new file.

32. The method of claim 30 or claim 31, comprising the step of automatically extracting an image from an archive to the new file.

33. The method of any of claims 18 to 32, further comprising the step of creating http slide shows that include preview images.

34. An image processing facility operable to receive a preview image file containing images of an event, to facilitate selection of an output destination for the preview image file wherein available output destinations include a further image processing facility and one or more clients, and to transmit the preview image file to the selected output destination.

35. A data file processing system for collecting data files containing data relating to an event and for distributing such data to one or more clients, the system comprising a terminal and a first editing facility; wherein
the terminal is configured to receive a master data file corresponding to data relating to the event, to store the master data file, to create a preview data file from the master image file where the preview data file has a smaller file size than the master data file, and is configured to transmit the preview data file to the first editing facility; and
the first editing facility is configured to transmit the preview data file to a client.

36. A computer when programmed:
to receive image files containing an image of an event;
to assign image files to one of a plurality of viewing lanes;
to display the plurality of viewing lanes, each viewing lane being displayed in a window and including the image or images associated with one or more image files assigned to that viewing lane;
to facilitate selection of an image from at least one of the plurality of viewing lanes and to display an enlarged view of the selected image;
to facilitate selection of a client; and
to send the image file associated with the selected image to the selected client.

37. The computer of claim 35, when programmed to facilitate editing of a selected image.

38. The computer of claim 36 or claim 37, when programmed to facilitate creation of a MMS message.

39. The computer of any of claims 36 to 38, when programmed to facilitate creation of a http slide show.

40. A computer program comprising program instructions for causing a computer to operate in accordance with any of claims 36 to 39.

41. A computer readable medium having a computer program according to claim 40 recorded thereon.

42. An image processing system substantially as described herein with reference to any of FIGS. 3 to 10.

41. A method of processing data relating to an event and for distributing such data to one or more clients substantially as described herein with reference to any of FIGS. 3 to 10.

42. A method of processing images taken at an event and for distributing a photograph so taken to one or more clients substantially as described herein with reference to any of FIGS. 3 to 10.
